(19) United States
(12) Patent Application Publication
(10) Pub. No.: US 2009/0082965 A1
(43) Pub. Date: Mar. 26, 2009

(54) Hard disk system and program for same

(75) Inventors: Makoto Tanaka, Anjo-city (JP); Motohiro Fukumoto, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/232,690

(22) Filed: Sep. 23, 2008

(30) Foreign Application Priority Data
Sep. 25, 2007 (JP) 2007-247402

(51) Int. Cl. G01C 21/00

(52) U.S. Cl. 701/213; 701/207

(57) ABSTRACT

An in-vehicle apparatus includes a position detector, a hard disk drive, a display, a speaker, an operation switch, a non-volatile memory, and a control unit. When it is determined that a current vehicle position is a low precision position where GPS signals cannot be received by the apparatus, an estimated travel range of a vehicle is set, and an operation of the hard disk drive is stopped in case that the estimated travel range is at least partially overlapping with a high-altitude area.

### CROSS REFERENCE TO RELATED APPLICATIONS

This application is based on and claims the benefit of priority of Japanese Patent Application No. 2007-247402 filed on Sep. 25, 2007, the disclosure of which is incorporated herein by reference.

### FIELD OF THE INVENTION

The present invention generally relates to a hard disk system for use in a vehicle that controls a hard disk drive and a program for the hard disk system.

### BACKGROUND INFORMATION

In recent years, in an in-vehicle navigation system which displays a map around a current position of a vehicle utilizing map data and performs traveling guidance by calculating an optimal route to a destination, a hard disk drive has been widely employed as a storage medium for storing the map data etc.

A hard disk drive performs reading and writing of data, with a magnetic head, on a magnetic disk coated with magnetic material as the storage medium. The hard disk drive has a structure in which a magnetic head positioned over the magnetic disk floats by a little amount from the rotating magnetic disk at the time of hard disk drive operation, by the pressure due to the viscosity of air generated by the rotation of the magnetic disk.

Therefore, when the hard disk drive operates under the environment where surrounding atmospheric pressure is extremely low, it may become impossible to maintain the spacing between the magnetic disk and the floating magnetic head in a proper state, due to the decrease of the air pressure which floats the magnetic head. As a result, there is a high risk of damaging the magnetic disk due to crashing of the magnetic head onto the magnetic disk.

Since the atmospheric pressure decreases in proportion as the altitude increases, there is a usage limit by altitude for the hard disk drive. Generally, the operation of the hard disk drive is guaranteed to an altitude up to the range from 3,000 m (about 0.7 atm) to 5,000 m (about 0.5 atm).

Consequently, when the use of an in-vehicle navigation system which includes a hard disk drive is assumed at a high-altitude place (for example, a road at an altitude of 3,000 meters or a road of 4,000 to 5,000 meter altitude) exceeding the altitude to which the operation of the hard disk drive is guaranteed, some measures for preventing the hard disk drive from a possible breakage are required.

Accordingly, to cope with the situation, a technique is devised in which, when a vehicle arrives at a place equal to or higher than a predetermined altitude (for example, 3,000 meters), an operation of a hard disk drive is stopped after alternatively storing a part of map data originally stored in the hard disk drive to an external memory, and route guidance is continuously performed by utilizing the map data stored in the external memory while the vehicle travels in the high-altitude place equal to or higher than 3,000 meters of altitude (refer to, for example, Japanese Patent Document JP-A-2004-317385, or its equivalent published as U.S. patent document 7,171,305). By utilizing such a technique, route guidance service becomes available without interruption even in a high-altitude place, while preventing the hard disk drive from breakage by stopping the operation of the hard disk drive.

In order to detect that a vehicle has arrived at a predetermined altitude, the commonly employed structure measures a current position by receiving position information, such as GPS information, with a receiver and confirms whether the vehicle has arrived at the predetermined altitude by referring to the map data which includes the altitude information. However, such structure cannot measure the current position of the vehicle in cases where a radio wave is shielded for a certain reason and the position information, such as the GPS information, cannot be received, for example, when the vehicle travels on the road in a tunnel or a valley, or when the vehicle travels in the neighborhoods of high-rise architectural structures, etc. In those cases, it is difficult to confirm that the vehicle has arrived at the predetermined altitude, leading to the breakage of the hard disk drive due to a failure of stopping the hard disk drive.

### SUMMARY OF THE INVENTION

The present invention has been made in view of the above and other circumstances, and provides a hard disk system and a program executable in the system, in which the operation of a hard disk is reliably stopped, even when the position information is unreceivable.

An aspect of the present invention provides an operation scheme of a hard disk system that determines a current position to be a high precision position when position information from a transmitter existing outside a vehicle can be received, and determines the current position to be a low precision position when the position information can not be received.

In cases where the current position is determined to be a high precision position, the vehicle is determined to be in a high-altitude traveling state when the vehicle position specified at least by the position information is located in a predetermined high-altitude area, and the vehicle is determined to be in a non-high-altitude traveling state when the vehicle position is not located in the high-altitude area.

The high-altitude area described here may be considered as an altitude area, for example, which exceeds the upper limit of the altitude to which the operation of a hard disk drive is guaranteed. The high-altitude traveling state denotes that the vehicle is traveling in the high-altitude area, and the non-high-altitude traveling state denotes that the vehicle is traveling in an outside range of the high-altitude area.

When the current position is determined to be a low precision position, the estimated travel range (i.e., an estimation range) of the vehicle is set up and the vehicle is determined to be in either one of the high-altitude traveling state and the non-high-altitude traveling state, according to the positional relationship of the high-altitude area and the area included in the estimated travel range.

The estimated travel range described here is set up based on the distance that the vehicle has traveled since the last position information has been received, and the vehicle position estimated from the traveling direction and speed of the vehicle. The estimated travel range includes an error which may be produced during the estimation of the position of the vehicle.

When the vehicle is determined to be in the high-altitude traveling state, the hard disk drive stops its operation.

In the hard disk system configured in this manner, when the position information cannot be received from outside of the vehicle, it is determined whether or not the vehicle is traveling in the high-altitude area, on the basis of the estimated travel range of the vehicle. When it is determined that the vehicle is traveling in the high-altitude area, the operation of the hard disk drive is stopped.

Since the estimated travel range described above considers the error produced during the estimation of the vehicle position, there is no possibility of erroneously determining that the vehicle is not traveling in the high-altitude area due to the estimation error of the vehicle position being considered, in spite of the fact that the vehicle is actually traveling in the high-altitude area. Consequently, even when the position information is unreceivable, the operation of the hard disk drive can be stopped securely. As a result, breakage of the hard disk drive by the operation equal to or lower than the operable lower limit of the atmospheric pressure can be prevented.

The program stored in a storage medium of the present invention is for controlling a computer system to be functioning as a control unit of the present invention.

The computer system controlled by the program can constitute some of the hard disk system of the present invention.

The program described above possesses a series of ordered instructions suitable for the processing by a computer system, and is supplied for an image processing device and/or a user of the image processing device, via various recording media or a communication line.

### BRIEF DESCRIPTION OF THE DRAWINGS

Other objects, features and advantages of the present invention will become more apparent from the following detailed description made with reference to the accompanying drawings, in which:

FIG. 1 shows a configuration of an in-vehicle apparatus in an embodiment of the present invention;

FIGS. 2A and 2B show illustrations of mesh of a coordinate plane and corresponding data of each of meshed coordinate planes;

FIG. 3 shows a flowchart of switching processing of operation of a hard disk drive;

FIG. 4 shows an illustration of an estimated travel range setting method;

FIG. 5 shows an illustration of high-altitude area determination at a high precision position; and

FIG. 6 shows an illustration of high-altitude area determination at a low precision position.

### DETAILED DESCRIPTION

Hereinafter, with reference to the accompanying drawings, the embodiments of the present invention are explained in detail.

(1) Overall Configuration

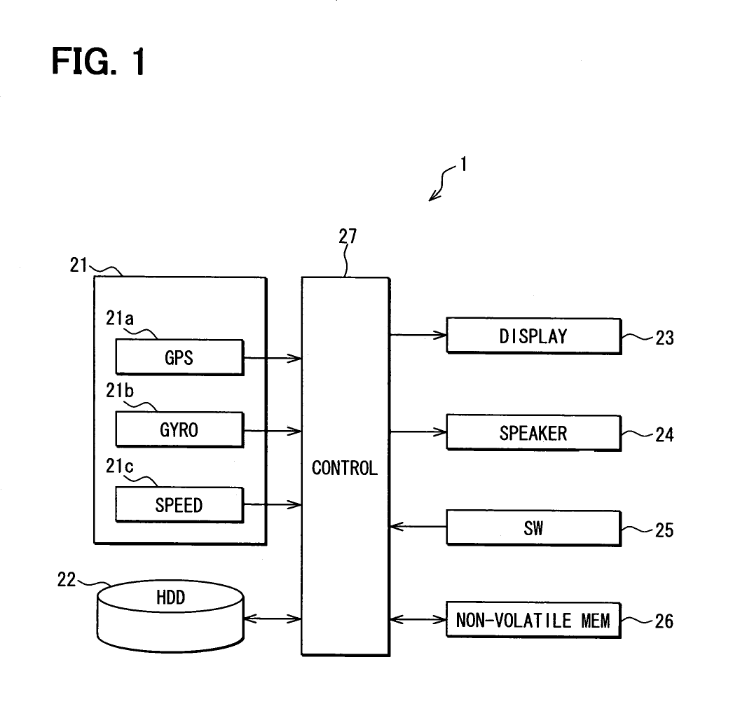

An in-vehicle apparatus 1 possesses a function of a navigation system, and includes, as illustrated in FIG. 1, a position detection apparatus 21 which detects the current position of a vehicle, a hard disk drive (HDD) 22, a display unit 23 which displays various images, such as a map display image, a voice output apparatus (speaker) 24 which outputs audio information, such as a guide voice, an operating switch group 25 for inputting various instructions from a user, a nonvolatile memory 26, and a control unit 27.

The position detection apparatus 21 possesses a GPS receiver 21a which receives GPS information from a GPS satellite via a GPS antenna and detects the position coordinate and altitude of a vehicle, a gyroscope 21b which outputs a detection signal according to an angular velocity of rotation applied to the vehicle, and a vehicle speed sensor 21c which outputs a detection signal corresponding to a speed of the vehicle. Since each of the sensors 21a-21c possesess an error with different properties, the sensors 21a-21c are used to complement one another.

When the GPS receiver 21a cannot receive the GPS information, the travel locus from the point at which the last GPS information is received is calculated to estimate the current position of the vehicle, based on the detection signal of the gyroscope 21b and the detection signal of the vehicle speed sensor 21c.

The hard disk drive 22 is a storage device in which a hard disk for storing information, a magnetic head for reading and writing information to the hard disk, a driving unit, a controller, etc. are assembled integrally. The hard disk described above possesses data storage regions to store application programs for operating the in-vehicle apparatus 1, map data indicating map information, and other various kinds of data. In addition to road data and drawing data necessary for realizing the navigation function, the map data stored in the hard disk drive 22 includes mesh data for determining a high-altitude area, etc.

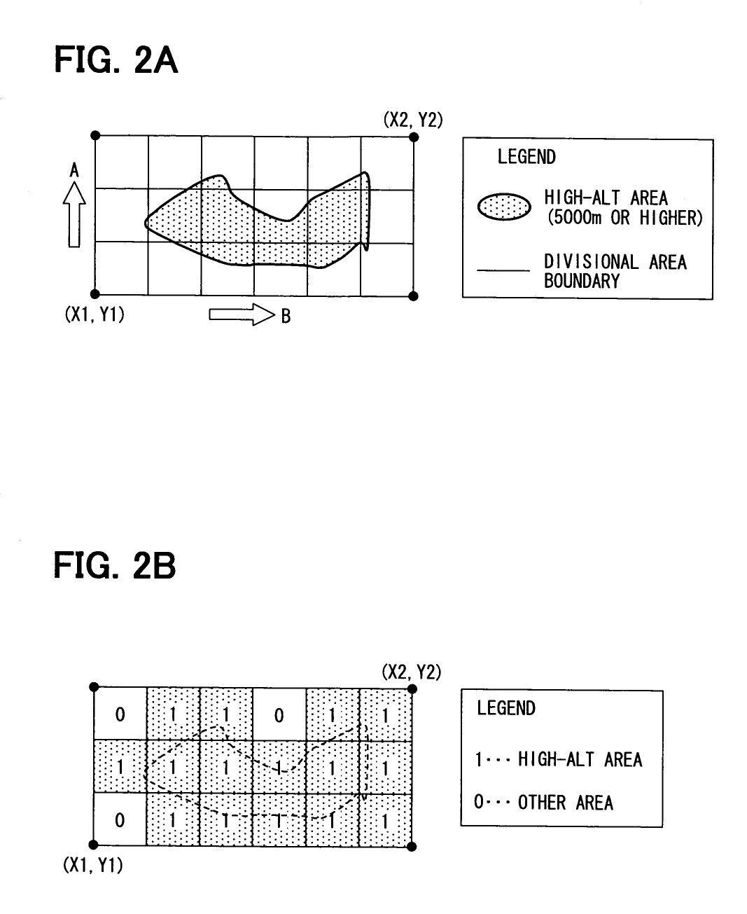

The mesh data described above is created in the following manner. First, as illustrated in FIG. 2A, the coordinate plane of a map is divided into meshes along the direction of latitude A and the direction of longitude B. As illustrated in FIG. 2B, data indicating whether an area corresponding to each mesh is a high-altitude area or a non-high-altitude area is set up for every area to create mesh data. The mesh data sets up a mesh which includes a high-altitude place (altitude equal to or higher than 5,000 meters) as a high-altitude area, and sets up-a mesh which does not include a high-altitude place at all as a non-high-altitude area.

The display unit 23 is a color display apparatus which possesses a screen surface such as a liquid crystal display, and displays various images on the screen surface according to the input of the video signal from the control unit 27. For example, while the vehicle is moving, a screen of a map indicated by the map data read from the hard disk drive 22 is displayed as a navigation display screen, with superimposition of a mark which indicates the current vehicle position detected by the position detection apparatus 21, a name, a mark, symbols of various landmarks, etc., and a guiding route to the destination.

The voice output apparatus 24 reports a variety of information to a user by voice. In this manner, various kinds of guidance including a route guide can be provided to a user, by the display of the display unit 23 and the voice output from the voice output apparatus 24.

The operating switch group 25 is integrated with the display unit 23, and includes a touch panel installed on the display apparatus screen surface, a mechanical key switch provided in the circumference of the display unit 23, etc.

The nonvolatile memory 26 stores a part of the application program stored in the hard disk drive 22 and the mesh data described above. When the operation of the hard disk drive 22 stops, required processing can be performed utilizing the data stored by the nonvolatile memory 26.

The control unit 27 possesses, as a core part, a commonly known microcomputer including a CPU, a ROM, a RAM, an I/O, a bus line that couples these components, and other parts. The control unit 27 controls the whole in-vehicle apparatus 1 described above. In addition, the control unit 27 practices the navigation-related processing, the hard disk drive operation switching processing to be described later, and other processing, according to the application program and various kinds of data which are read from the ROM, the hard disk drive 22, the nonvolatile memory 26, etc.

The navigation-related processing includes map display processing, route guidance processing, etc., for example. The map display processing calculates the current position of a vehicle based on the detection signals from the position detection apparatus 21, and displays a map around the current position, etc. on the display unit 23 based on the map data stored in the hard disk drive 22. The route guidance processing calculates a destination route, which is an optimal route from the current position to the destination set up by operation of the operating switch group 25 by a user, based on the map data stored in the hard disk drive 22, and performs traveling guidance to the destination in consideration of the relationship between the current position and the destination route. As a technique of setting up the optimal route automatically in this way, a technique such as a cost calculation by the Dijkstra's algorithm is known.

(2) Switching Processing of Operation of a Hard Disk Drive

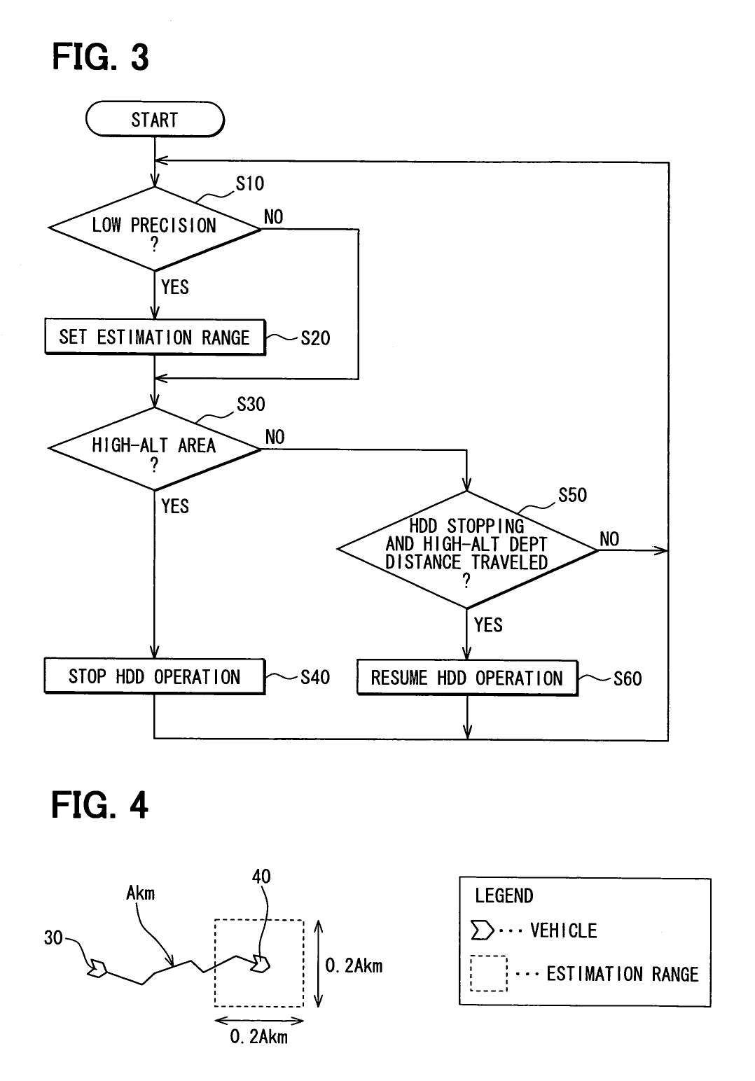

In the following, the procedure of switching processing of operation of the hard disk drive by the control unit 27 is explained, with reference to FIG. 3.

The switching processing of operation of a hard disk drive is started immediately after the hard disk drive 22 starts its operation, with the start of the in-vehicle apparatus 1 when an accessory switch of the vehicle is turned on. The switching processing of operation of a hard disk drive is performed in parallel with the map display processing, the route guidance processing, etc. described above.

In the switching processing of operation of a hard disk drive, based on the receiving condition of the GPS information, it is confirmed first whether or not the current position is a “low precision position” (Step S10). Here, when a non-positioning duration determined in advance (e.g., five minutes in the present embodiment) has not elapsed after receiving the GPS information, the current position is determined to be a “high precision position”, and when the non-positioning duration has elapsed, the current position is determined to be a “low precision position.”

When the current position is determined to be a “low precision position” as a result of the determination (YES at Step S10), the processing moves to Step S20. On the other hand, when the current position is determined to be a “high precision position” (NO at Step S10), the processing moves to Step S30. The non-positioning duration is set as suitable time so that switching from a high precision position to a low precision position does not take place immediately when the GPS information becomes temporarily unreceivable due to the vehicle environment such as a high-rise architectural structure, a tunnel, a valley, etc.

When the current position is determined to be a “low precision position” at Step S10, an estimated travel range of the vehicle is set up (Step S20). The estimated travel range of the vehicle is set up as follows. First, as illustrated in FIG. 4, the point at which the last GPS information is received is defined as a reference point 30. The travel locus from the reference point 30 is calculated based on the detection signals outputted from the gyroscope 21b and the vehicle speed sensor 21c of the position detection apparatus 21, and the current position 40 of the vehicle is estimated. Centering on the current position 40, a square estimated travel range is set up, with one side of length of 20% of the distance that the vehicle has traveled from the time when the last GPS information has been received (i.e., 20% of the length from the reference point 30 to the current position 40). The estimated travel range is set up so that each side of the square may become substantially parallel with the direction of latitude or the direction of longitude in the position relationship.

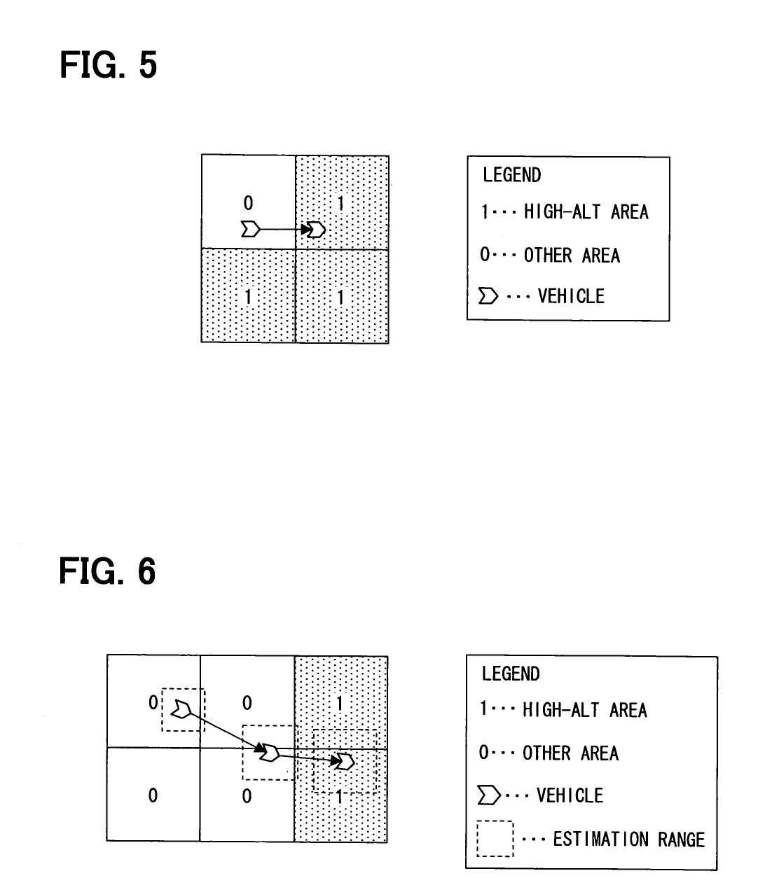

Next, it is determined whether the vehicle is positioned in a high-altitude area using the mesh data described above (Step S30). Here, when the current position is determined to be a “high precision position” at Step S10, as illustrated in FIG. 5, it is determined whether the current position of the vehicle detected by the position detection apparatus 21 is positioned in the area set up as a high-altitude area. On the other hand, when the current position is determined to be a “low precision position” at Step S10, as illustrated in FIG. 6, it is determined whether the estimated travel range set up at Step S20 overlaps with a mesh set up as a high-altitude area. When it is determined to be overlapping even partially, it is determined that the vehicle is positioned in a high-altitude area.

When it is determined that the vehicle is positioned in the high-altitude area (when the vehicle is in a high-altitude traveling state) (YES at Step S30), the processing moves to Step S40. When it is not determined that the vehicle is positioned in the high-altitude area (when the vehicle is in a non-high-altitude traveling state), (NO at Step S30), the processing moves to Step S50.

When it is determined that the vehicle is positioned in the high-altitude area at Step S30, the operation of the hard disk drive 22 is stopped (Step S40). When the operation of the hard disk drive 22 has already been stopped, stopping of the hard disk operation is continued. After the operation of the hard disk drive 22 is stopped, each processing of the in-vehicle apparatus 1 is continued utilizing the various kinds of data stored in the nonvolatile memory 26, until the operation of the hard disk drive 22is resumed. Then, the processing returns to Step S10.

When it is not determined that the vehicle is positioned in a high-altitude area at Step S30, it is determined whether the operation of the hard disk drive 22 is stopped, and whether the vehicle has traveled the distance more than a high-altitude departure deciding distance from the timing when the vehicle has left the high-altitude area (Step S50). The timing when the vehicle leaves the high-altitude area is the timing when the vehicle is determined no longer “to be positioned in the high-altitude area” at Step S30.

When it is determined that the operation of the hard disk drive 22 is stopped, and that the vehicle has traveled the distance more than the high-altitude departure deciding distance (YES at Step S50), the operation of the hard disk drive 22 is resumed (Step S60), then, the processing returns to Step S10.

On the other hand, when the hard disk drive 22 is operating, or when it is determined that the vehicle has not traveled the distance more than the high-altitude departure deciding distance (NO at Step S50), the processing returns to Step S10.

The high-altitude departure deciding distance described above is a marginal distance for preventing the hard disk drive 22 from repeating the start and stop of operation frequently, in the state where the vehicle travels near the boundary line between the high-altitude area and the non-high-altitude area only to cause a frequent switching between the high-altitude traveling state and the non-high-altitude traveling state.

(3) Advantageous Effects

In the in-vehicle apparatus 1 configured as described above, even in a case where the GPS information is unreceivable, it is determined whether or not the vehicle is traveling in a high-altitude area by estimating the position of the vehicle in the range which includes the error accompanying the estimation. Therefore, the start and stop of operation of the hard disk drive 22 can be controlled to be serving on the safety side, and failure of the hard disk drive 22 by the operation below the operable lower limit of the atmospheric pressure can be securely prevented.

(4) Modifications

In the above embodiment, the present invention has been described. It cannot be overemphasized that the present invention is not limited to the embodiment described above at all, and various modifications can be practiced as far as they belong to the technical scope of the present invention.

In the embodiment described above, the configuration is illustrated in which the in-vehicle apparatus 1 possesses the nonvolatile memory 26 which stores mesh data etc. beforehand, and reads data from the nonvolatile memory 26 when the hard disk drive 22 is stopped. However, as long as the data can be read when the hard disk drive 22 is stopped, any concrete form of configuration may be adopted.

For example, it is also effective to provide configuration in which only required data among the data stored in the hard disk drive 22 is copied to the nonvolatile memory 26 at the timing when the in-vehicle apparatus 1 is started or at the timing when the vehicle enters into a predetermined area. With the configuration provided in this manner, it becomes unnecessary for the nonvolatile memory 26 to always hold the unnecessary data, such as the mesh data of the position greatly distant away from the current position of the vehicle. Therefore, the nonvolatile memory 26 with a smaller storage capacity can be used. When such configuration is provided, a volatile memory may be employed in place of the nonvolatile memory 26.

In the embodiment described above, the length of the one side of the square estimated travel range is set as 20% of the distance that the vehicle has traveled after the last GPS information is received. However, the percentage is not restricted in particular. Since the position of the vehicle can be restricted to be in a smaller range as the length of one side of the estimated travel range is reduced, it is effective to shorten the length of one side of the estimation range, if the error of the vehicle position estimated from the gyroscope 21b and the vehicle speed sensor 21c can be reduced. The configuration is not restricted to the cases where the length of one side increases in proportion to the distance that the vehicle has traveled; however, it is also effective that the length of one side increases stepwise as the distance increases.

In the embodiment described above, it is exemplified that the estimated travel range is a square centering on the estimated position of the vehicle. However, the center of the estimated travel range may be different from the estimated position of the vehicle, and, the estimated travel range may be different from a square shape. For example, with reference to road data, a range along a road may be selectively set as the estimated travel range, and an area where a vehicle does not usually travel, such as a marine area, a lake, or the like, may be excluded from the estimated travel range. Furthermore, the estimated travel range may be in a circular shape, in stead of the square shape.

In the embodiment described above, use of the mesh data is exemplified in which the area on a map is set as either of a high-altitude area and a non-high-altitude area. However, the area may be divided more in detail. For example, an altitude area near the high-altitude place (for example, an area of altitude equal to or greater than 3,000 meters and less than 5,000 meters) may be set as a quasi-high-altitude area, and when a vehicle enters into the quasi-high-altitude area, the setup of the estimated travel range may be started, or the data of the hard disk drive 22 may be copied to the nonvolatile memory 26.

In the embodiment described above, it is exemplified that a current position is determined to be a low precision position when a predetermined time has elapsed, after the last reception of the GPS information. Alternatively, the current position may be determined to be a low precision position when a vehicle travels a predetermined distance, after the last reception of the GPS information.

Furthermore, in the embodiment described above, it is exemplified that the operation of the hard disk drive 22 is resumed when the vehicle has traveled the distance more than the high-altitude departure deciding distance after leaving the high-altitude area. Alternatively, the operation of the hard disk drive 22 may be resumed when a predetermined time has elapsed after leaving the high-altitude area.

Furthermore, in the embodiment described above, the configuration is illustrated in which the GPS information transmitted from the artificial satellite for GPS is received by the GPS receiver 21a. However, as long as position information can be received from a transmitter outside of the vehicle, any concrete form of configuration may be adopted. For example, it is conceivable that the position information may be received from a communication device arranged near the road.

(5) Correspondence Relation

In the embodiment described above, the in-vehicle apparatus 1 corresponds to a hard disk system in the present invention, the GPS receiver corresponds to a position information receiving unit in the present invention, and the control unit 27 corresponds to a position estimation unit, a reception determination unit, an estimated travel range setting unit, a traveling state determination unit, and a hard disk operation switching unit in the present invention.

What is claimed is:

1. A hard disk system mounted in a vehicle, the hard disk system comprising:
a hard disk drive;
a control unit operable to control the hard disk drive; and
a position information receiving unit operable to receive position information indicative of a position of the vehicle from a transmitter existing outside the vehicle,
wherein the control unit includes:
a position estimation unit operable to estimate the position of the vehicle by measuring a traveling direction and a traveling speed of the vehicle;
a reception determination unit operable to determine a current position to be a high precision position when the position information receiving unit can receive the position information, and to determine the current position to be a low precision position when the position information receiving unit can not receive the position information;
an estimated travel range setting unit operable to set an estimated travel range of the vehicle, when the reception determination unit determines the current position to be the low precision position, based on a distance that the vehicle has traveled since the position information receiving unit has received the position information for the last time and a position of the vehicle estimated by the position estimation unit;
a traveling state determination unit operable to determine the vehicle to be in one of a high-altitude traveling state and a non-high-altitude traveling state; and
a hard disk operation switching unit operable to deactivate the hard disk drive when the traveling state determination unit determines the vehicle to be in the high-altitude traveling state,
wherein, in cases where the reception determination unit determines the current position to be the high precision position, the traveling state determination unit determines the vehicle to be in the high-altitude traveling state if the vehicle position specified on the basis that at least the position information received by the position information receiving unit is located in a predetermined high-altitude area, and the traveling state determination unit determines the vehicle to be in the non-high-altitude traveling state if the vehicle position is not located in the predetermined high-altitude area, and
wherein, in cases where the reception determination unit determines the current position to be the low precision position, the traveling state determination unit determines the vehicle to be in one of the high-altitude traveling state and the non-high-altitude traveling state depending on a positional relation between an area included in the estimated travel range set by the estimated travel range setting unit and the high-altitude area.

2. The hard disk system of claim 1,
wherein the hard disk operation switching unit starts activating the hard disk drive after the traveling state determination unit determines the vehicle to be in the non-high-altitude traveling state while the hard disk drive is in a deactivated state.

3. The hard disk system of claim 1,
wherein, in cases where the reception determination unit determines the current position to be the low precision position, the traveling state determination unit determines the vehicle to be in the high-altitude traveling state when the area included in the estimated travel range overlaps the high-altitude area at least partly and determines the vehicle to be in the non-high-altitude traveling state when the area included in the estimated travel range does not overlap the high-altitude area.

4. The hard disk system of claim 1,
wherein the estimated travel range setting unit sets as the estimated travel range an area corresponding to a distance traveled by the vehicle since the position information receiving unit has received the position information for a last time, and the area having a center at the vehicle position estimated by the position estimation unit.

5. The hard disk system of claim 1,
wherein the case where it is possible for the position information receiving unit to receive the position information denotes a case where a predetermined time period has not elapsed since the position information receiving unit received the position information for a last time, and
wherein the case where it is impossible for the position information receiving unit to receive the position information denotes a case where the predetermined time has elapsed since the position information receiving unit received the position information for a last time.

6. The hard disk system of claim 1,
wherein the position information receiving unit receives GPS information as the position information.

7. A storage medium readable by a computer system, the storage medium storing a program of instructions executable by the computer system to perform a function of the control unit of claim 1.
